(19) United States
(12) Patent Application Publication
(10) Pub. No.: US 2003/0163396 A1
(43) Pub. Date: Aug. 28, 2003

(54) Systems and methods for tracking products as they move through a supply chain

(76) Inventors: John Blankevoort, Salt Lake City, UT (US); Paul Hepworth, Riverton, UT (US); George Powell, Sandy, UT (US); Ryan Hyde, Draper, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/374,881

(22) Filed: Feb. 26, 2003

Related U.S. Application Data
(60) Provisional application No. 60/360,018, filed on Feb. 27, 2002.

(51) Int. Cl. G06F 17/60

(52) U.S. Cl. 705/28

(57) ABSTRACT

A method for tracking products as they move through a supply chain is disclosed. The method involves using an identification tag reader to scan a machine-readable identification tag that is attached to a first product. The machine-readable identification tag includes an encoded version of a product identifier that uniquely identifies the first product. The identification tag reader decodes the encoded version of the product identifier and obtains the product identifier. A product database is then accessed to determine whether a next action that may be taken with respect to the first product is allowable. The next action is not allowable unless a current value of a state associated with the product identifier in the product database is equal to one of a set of allowed values.

### RELATED APPLICATIONS

This application is related to and claims priority from U.S. Provisional Patent Application Serial No. 60/360,018 filed Feb. 27, 2002, for “Authentication System and Method for Products Marked With Machine-Readable Graphical Codes,” with inventors John Blankevoort, Paul Hepworth, George Powell, and Ryan Hyde, which is incorporated herein by reference.

### TECHNICAL FIELD

The present invention relates generally to the field of supplying products to consumers. More specifically, the present invention relates to systems and methods for tracking products as they move through a supply chain.

### BACKGROUND

A supply chain is a network of individuals and/or organizations that interact in order to supply products to consumers. A trading partner is any individual or organization that participates in a supply chain. Examples of trading partners include suppliers, manufacturers, distributors, transporters, wholesalers, retailers, and the like. A product moves through a supply chain when it passes from one trading partner to another. A supply chain may be relatively simple, involving only a few different trading partners. Alternatively, a supply chain may be relatively complex, involving many different trading partners.

Counterfeiters sometimes produce products which are copies of those produced by their original manufacturers. These counterfeit products may then be introduced into one or more supply chains and ultimately sold to consumers. Products produced by well-known manufacturers are often the target of such counterfeiting activities.

If counterfeit products are not detected and removed from a supply chain at some point before they are purchased by consumers, negative consequences can result. For example, lost sales may occur for the original manufacturer. End users may be deceived regarding the source of the goods and/or their quality. The strength and reputation of the trademarks associated with the manufacturers' products may be diminished.

A machine-readable identification tag is any machine-readable tag or device that is capable of uniquely identifying a product. Examples of machine-readable identification tags include bar codes, matrix codes, radio-frequency identification (RFID) tags, magnetic stripes, smart cards, punch cards, and so forth. Devices for identifying or extracting information from machine-readable identification tags are generally referred to as identification tag readers.

Machine-readable identification tags and identification tag readers have been used to address the problem of counterfeiting. However, previous attempts to address the problem of counterfeiting have not been entirely successful. This is likely due to a combination of outdated industry technology and the absence of a system architecture that allows for symbologies to be dynamically linked from paper, product, and process to digital data.

Accordingly, benefits may be realized if means were provided to address one or more of the above problems.

### BRIEF DESCRIPTION OF THE DRAWINGS

FIG. 1 is a block diagram of an embodiment of a system for tracking products as they move through a supply chain;

FIG. 2 is a block diagram illustrating an embodiment of a product database;

FIG. 3 is a block diagram illustrating an embodiment of a server software module;

FIG. 4 is a flow diagram illustrating an embodiment of a method for tracking products as they move through a supply chain;

FIG. 5 is a flow diagram illustrating another embodiment of a method for tracking products as they move through a supply chain;

FIG. 6 is a flow diagram illustrating another embodiment of a method for tracking products as they move through a supply chain; and

FIG. 7 is a block diagram of hardware components that may be used in an embodiment of a computing device.

### DETAILED DESCRIPTION

It will be readily understood that the components of the embodiments as generally described and illustrated in the Figures herein could be arranged and designed in a wide variety of different configurations. Thus, the following more detailed description of various embodiments of the present invention, as represented in the Figures, is not intended to limit the scope of the invention, as claimed, but is merely representative of the embodiments of the invention.

Several aspects of the embodiments described herein will be illustrated as software modules stored in a computing device. As used herein, a software module may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

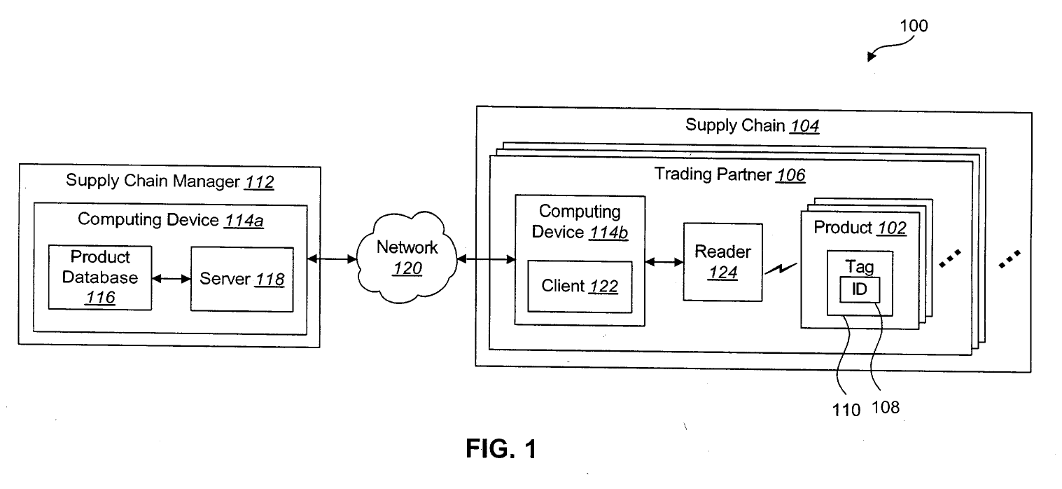

FIG. 1 is a block diagram of an embodiment of a system 100 for tracking products 102 as they move through a supply chain 104. As described previously, a supply chain 104 is a network of individuals and/or organizations that interact in order to supply products 102 to consumers. A trading partner 106 is any individual or organization that participates in the supply chain 104. Examples of trading partners 106 include suppliers, manufacturers, distributors, transporters, wholesalers, retailers, and the like. A product 102 moves through the supply chain 104 when it 102 passes from one trading partner 106 to another.

Each product 102 that moves through the supply chain 104 is uniquely associated with a product identifier 108. That is, the product identifier 108 uniquely identifies the particular product 102 and does not uniquely identify any other products 102. A machine-readable identification tag 110 is attached to each product 102. The identification tag 110 attached to a particular product 102 includes an encoded version of the product identifier 108 associated with the product 102.

In some embodiments, the product identifiers 108 are selected using a random or pseudo-random number generator, and the set of product identifiers 108 placed into use is a fraction of the set of possible product identifiers 108. For example, the set of possible product identifiers 108 might have 16 quadrillion possible values (such as a 64-bit number) and the set of product identifiers 108 placed into use might be limited to 16 million product identifiers 108 randomly distributed throughout the set of possible product identifiers 108.

The system 100 shown in FIG. 1 includes a supply chain manager 112. The supply chain manager 112 maintains information about the products 102 that move through the supply chain 104. The supply chain manager 112 also makes this information available to the trading partners 106 in the supply chain 104, as will be described in greater detail below.

The supply chain manager 112 and trading partners 106 each have access to a computing device 114. As used herein, a computing device 114 is any device that includes a digital processor capable of receiving and processing data. A computing device 114 includes the broad range of digital computers including personal computers, hand-held computers, servers, mainframes, supercomputers, microcontrollers, and the like.

For purposes of clarity, the computing device 114 used by the supply chain manager 112 will be referred to herein as a primary computing device 114a, and the computing devices 114 used by the trading partners 106 will be referred to herein as secondary computing devices 114b. However, the terms “primary” and “secondary” are used for identification purposes only, and should not be construed to suggest anything about the computing devices 114 themselves.

As stated previously, the supply chain manager 112 maintains information about the products 102 that move through the supply chain 104. This information is stored on the primary computing device 114a in the form of a product database 116. The product database 116 includes the product identifiers 108 that are associated with the products 102 that move through the supply chain 104. Additional details about various embodiments of the product database 116 will be provided below.

The primary computing device 114a also includes a server software module 118. The server software module 118 controls access to the product database 116. In some embodiments, the server software module 118 includes a dynamic web server. Additional details about various embodiments of the server software module 118 will be provided below.

The secondary computing devices 114b are in communication with the primary computing device 114a over one or more networks 120. As used herein, a network 120 refers to any system that facilitates the transmission of data between the primary computing device 114a and one or more secondary computing devices 114b. Examples of networks 120 include the Internet, a local area network, a wide area network, a wireless network, and the like.

The secondary computing devices 114b each include a client software module 122. A trading partner 106 may use the client software module 122 to access the product database 116. In some embodiments, the client software module 122 is a web browser.

Each secondary computing device 114b is also in communication with an identification tag reader 124. An identification tag reader 124 is a device for reading machine-readable identification tags 110, i.e., decoding data contained in machine-readable identification tags 110. The identification tag reader 124 is used to read the machine-readable identification tags 110 that are attached to products 102 that move through the supply chain 104.

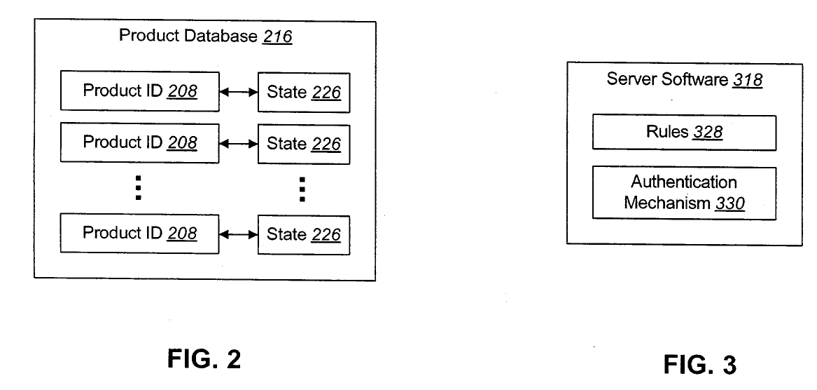

FIG. 2 is a block diagram illustrating an embodiment of a product database 216. The product database 216 includes a plurality of product identifiers 208. Each product identifier 208 is associated with a single product 102 that moves through the supply chain 104. In some embodiments, the supply chain manager 112 adds the product identifiers 208 to the product database 216. In other embodiments, manufacturers of products 102 add the product identifiers 208 to the product database 216.

A state 226 is associated with each product identifier 208. The value of the state 226 associated with a product identifier 208 indicates a condition of the product 102 associated with the product identifier 208. For example, if the value of a state 226 associated with a product identifier 208 is “manufactured,” this indicates that the product 102 associated with the product identifier 208 has been manufactured. If the value of a state 226 associated with a product identifier 208 is “inspected,” this indicates that the product 102 associated with the product identifier 208 has been inspected. The states 226 associated with a product identifier 208 could assume any number of values, including “manufactured,” “inspected,” “shipped,” “received,” “sold,” “returned,” and the like.

FIG. 3 is a block diagram of an embodiment of the server software module 318. As described previously, the server software module 318 controls access to the product database 116. In some embodiments, the server software module 318 enforces a plurality of rules 328. The rules 328 specify the conditions under which the state 226 associated with a product identifier 108 may be changed.

In some embodiments, the server software module 318 includes one or more rules 328 which indicate that a state 226 may only be changed to a new value if the current value of the state 226 is equal to one of a set of allowed values. A set of allowed values may include a plurality of allowed values or a single allowed value. For example, a rule 328 may indicate that a state 226 may only be changed to “inspected” if the current value of the state 226 is “manufactured.” Another rule 328 may indicate that a state 226 may only be changed to “shipped” if the current value of the state 226 is “manufactured” or “inspected.” Another rule 328 may indicate that a state 226 may only be changed to “received” if the current value of the state 226 is “manufactured,” “inspected,” or “shipped.” Another rule 328 may indicate that a state 226 may only be changed to “sold” if the current value of the state 226 is “received” or “returned.” Another rule 328 may indicate that a state 226 may only be changed to “returned” if the current value of the state 226 is “sold.”

The server software module 318 may also include one or more rules 328 which indicate that a state 226 may only be changed to a new value by one of a plurality of authorized parties. For example, a rule 328 may indicate that only authorized manufacturers may change a state 226 to “manufactured.” Another rule 328 may indicate that only authorized inspectors may change a state 226 to “inspected.” Another rule 328 may indicate that only authorized shippers may change a state 226 to “shipped.” Another rule 328 may indicate that only authorized warehouses, wholesalers, and retailers may change a state 226 to “received.” Another rule 328 may indicate that only authorized retailers may change a state 226 to “sold.” Another rule 328 may indicate that only authorized retailers may change a state 226 to “returned.”

The server software module 318 shown in FIG. 3 also includes an authentication mechanism 330. The authentication mechanism 330 is used to determine the identity of parties that make requests to the server software module 318. This information may be useful in enforcing rules 328 which specify that a state 226 may only be changed to a new value by one of a plurality of authorized parties. Authentication mechanisms 330 are known to those skilled in the art. Examples of different authentication mechanisms 330 include implementations of various security protocols, such as Transport Layer Security (TLS), Secure Sockets Layer (SSL), Kerberos, and the like. In some embodiments, an authentication mechanism 330 may simply be based on a system of encrypted usernames and passwords.

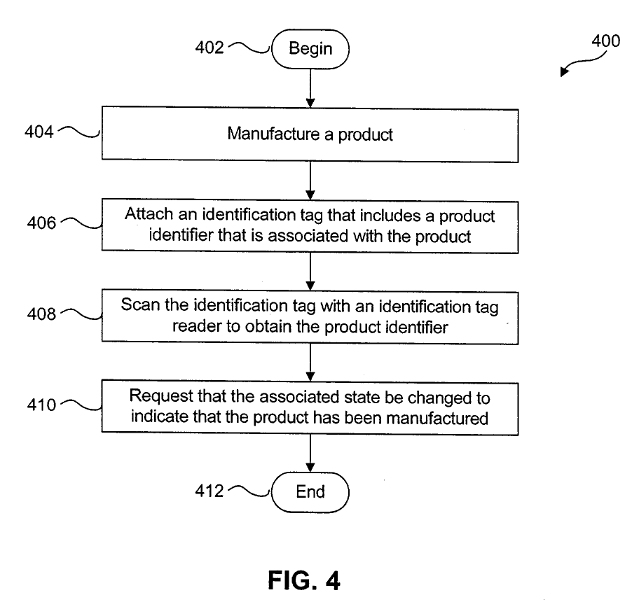

FIG. 4 is a flow diagram of an embodiment of a method 400 for tracking products 102 as they move through a supply chain 104. The method 400 shown in FIG. 4 is typically performed by a manufacturer. The method 400 begins 402 when a product 102 is manufactured 404. An identification tag 110 is then attached 406 to the product 102. The identification tag 110 includes an encoded version of a product identifier 108. The product identifier 108 uniquely identifies the product 102, and the product identifier 108 does not uniquely identify any other products 102.

The identification tag 110 that is attached 406 to the product 102 may be obtained in many different ways. In some embodiments, the supply chain manager 112 generates a plurality of machine-readable identification tags 110 that contain different product identifiers 108. The manufacturers then obtain these machine-readable identification tags 110 from the supply chain manager 112. In other embodiments, the supply chain manager 112 provides manufacturers with parameters for generating product identifiers 108. The manufacturers may then themselves generate machine-readable identification tags 110 containing the product identifiers 108.

The identification tag 110 is then scanned 408 with an identification tag reader 124. As described previously, an identification tag reader 124 is a device for decoding data contained in machine-readable identification tags 110. The identification tag reader 124 decodes the encoded version of the product identifier 108 and obtains the product identifier 108. The identification tag reader 124 typically provides the product identifier 108 to a client software module 122 stored on a secondary computing device 114b.

The method 400 may then involve requesting 410 that the state 226 associated with the product identifier 108 in the product database 116 be changed to indicate that the product 102 has been manufactured. For example, the request may be to change the state 226 to a value of “manufactured.” The client software module 122 may be used to make the request, which is typically sent to the server software module 118. The method 400 may then end 412.

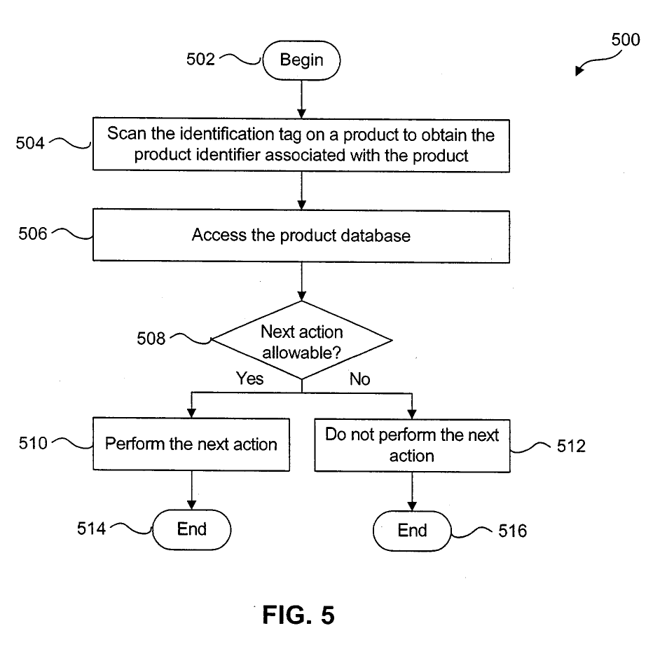

FIG. 5 is a flow diagram of another embodiment of a method 500 for tracking products 102 as they move through a supply chain 104. The method 500 shown in FIG. 5 may be performed at various times by various trading partners 106 as a product 102 moves through the supply chain 104. Typically, the method 500 is performed when a particular action is about to be taken with respect to a product 102. For example, the method 500 may be performed when a product 102 is about to be inspected, when a product 102 is about to be shipped from one trading partner 106 to another, when a product 102 is about to be sold to a consumer, and so forth.

The method 500 begins 502 when the identification tag 110 on a product 102 is scanned 504 with an identification tag reader 124. As described previously, the identification tag 110 includes an encoded version of a product identifier 108. The product identifier 108 uniquely identifies a product 102, and the product identifier 108 does not uniquely identify any other products 102. The identification tag reader 124 decodes the encoded version of the product identifier 108 and obtains the product identifier 108. The identification tag reader 124 typically provides the product identifier 108 to a client software module 122 stored on a secondary computing device 114b.

The product database 116 is then accessed 506. Typically, a client software module 122 is used to access the product database 116 through the server software module 118. It is then determined 508 whether the action that is about to be taken with respect to the product 102 is allowable. Typically, this determination is made by attempting to change the value of the state 226 that is associated with the corresponding product identifier 108 in the product database 116 to a new value that is indicative of the action that is about to be taken. For example, if the product 102 is about to be shipped, an attempt may be made to change the value of the state 226 to “shipped.” If the rules 328 enforced by the server software module 118 do not prevent the state 226 from being changed to the new value, then it may be concluded that the action is allowable.

If it is determined 508 that the next action is allowable, the product 102 is likely authentic, and the next action is performed 510. If it is determined 508 that the next action is not allowable, the product 102 is likely a counterfeit product 102, and the next action is not performed 512. The method 500 then ends 514, 516. In some embodiments, once it is determined 508 that the next action is not allowable, the product 102 may be removed from the supply chain 104.

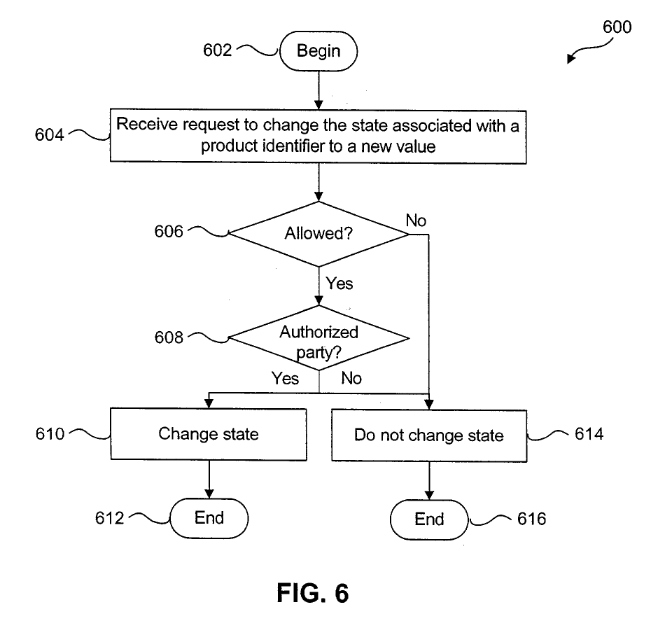

FIG. 6 is a flow diagram of another embodiment of a method 600 for tracking products 102 as they move through a supply chain 104. The method 600 shown in FIG. 6 is typically performed by the server software module 118.

The method 600 begins 602 by receiving 604 a request to change the state 226 associated with a product identifier 108 in the product database 116 to a new value. It is then determined 606 whether the current value of the state 226 is equal to one of a set of allowed values that is associated with the new value. Typically, the set of allowed values associated with the new value is specified in the rules 328 which the server software module 118 enforces, as discussed above.

It is then determined 608 whether the request received in step 604 was sent from one of a plurality of authorized parties. Typically, the parties that are authorized to change a state 226 to a particular value are specified in the rules 328 which the server software module 118 enforces, as discussed above. The authentication mechanism 330 may be used to determine the identity of the party that made the request.

If the current value of the state 226 is equal to one of the set of allowed values associated with the new value, and if the request was sent from an authorized party, the value of the state 226 is changed 610, and the method ends 612. If either of those conditions is not satisfied, the value of the state 226 is not changed 614, and the method ends 616.

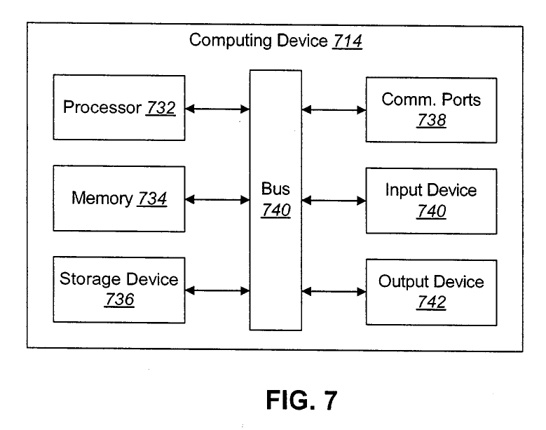

FIG. 7 is a block diagram of hardware components that may be used in an embodiment of a computing device 714. Many different types of computer systems may be used to implement the computing devices 7114 illustrated herein. The diagram of FIG. 7 illustrates typical components of a computing device 714 including a processor 732, memory 734, a storage device 736, and one or more communication ports 738. A bus 740 electronically couples all of the components in the computing device 714. Each of these components is known to those skilled in the art.

It will be appreciated by those skilled in the art that more components may be included in the computing device 714. For example, several input devices 740 may be included, such as a keyboard, a mouse, a joystick, etc. In addition, several output devices 742 may be included, such as a display screen, a printer, etc. Thus, those skilled in the art will appreciate that additional components may be added to the computing device 714 without detracting from the functionality to serve as a computing device 714.

Advantageously, the systems and methods disclosed herein may be used to address the problem of counterfeiting. For example, if an identification tag 110 is not attached to a product 102, it may be concluded that the product 102 is a counterfeit, and the product 102 may be eliminated from the supply chain 104.

As another example, suppose that a counterfeiter has a copy of a single, authentic identification tag 110, and that the product identifier 108 contained in the identification tag 110 is associated with a state of “sold” in the product database 116. The counterfeiter may attach the authentic identification tag 110 to a counterfeit product 102. The rules 328 may be configured to prevent a wholesaler or retailer from receiving a product 102 that is associated with a state of “sold.” In this scenario, the counterfeit product 102 will be prevented from entering the supply chain 104 through a wholesaler or retailer.

As another example, suppose that a counterfeiter has a copy of a single, authentic identification tag 110, and that the product identifier 108 contained in the identification tag 110 is associated with a state of “received” in the product database 116. The counterfeiter may attach the authentic identification tag 110 to a counterfeit product 102. The rules 328 may be configured to prevent a wholesaler or retailer from receiving a product 102 that is already associated with a state of “received.” In this scenario, the counterfeit product 102 will be prevented from entering the supply chain 104 through a wholesaler or retailer.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the embodiments disclosed herein without departing from the spirit and scope of the invention.

What is claimed is:

1. A method for tracking products as they move through a supply chain, the method comprising:
manufacturing a first product;
attaching a machine-readable identification tag to the first product, wherein the machine-readable identification tag comprises an encoded version of a product identifier, and wherein the product identifier uniquely identifies the first product; and
requesting that a state associated with the product identifier in a product database be changed from a current value to a new value which indicates that the first product has been manufactured, wherein the product database is accessible to trading partners in the supply chain.

2. The method as defined in claim 1, wherein a server software module controls access to the product database.

3. The method as defined in claim 2, wherein the server software module enforces a first rule which indicates that the state is not changed to the new value unless the current value is equal to one of a set of allowed values.

4. The method as defined in claim 3, wherein the server software module enforces a second rule which indicates that the state is only changeable to the new value by a plurality of authorized parties, and wherein the server software module comprises an authentication mechanism for determining whether a request to change the state to the new value is sent from one of the plurality of authorized parties.

5. The method as defined in claim 1, further comprising using an identification tag reader to scan the machine-readable identification tag, wherein the identification tag reader decodes the encoded version of the product identifier and obtains the product identifier.

6. A method for tracking products as they move through a supply chain, the method comprising:
using an identification tag reader to scan a machine-readable identification tag that is attached to a first product, wherein the machine-readable identification tag comprises an encoded version of a product identifier that uniquely identifies the first product, and wherein the identification tag reader decodes the encoded version of the product identifier and obtains the product identifier;
accessing a product database to determine whether a next action with respect to the first product is allowable, wherein the next action is not allowable unless a current value of a state associated with the product identifier in the product database is equal to one of a set of allowed values; and
performing the next action with respect to the first product only if the next action is allowable.

7. The method as defined in claim 6, wherein a server software module controls access to the product database.

8. The method as defined in claim 7, wherein the server software enforces a first rule which indicates that the state is not changed to the new value unless the current value is equal to one of the set of allowed values.

9. The method as defined in claim 8, wherein the server software enforces a second rule which indicates that the state is only changeable to the new value by a plurality of authorized parties, and wherein the server software comprises an authentication mechanism for determining whether a request to change the state to the new value is sent from one of the plurality of authorized parties.

10. A method for tracking products as they move through a supply chain, the method comprising:
receiving a request to change a state associated with a product identifier in a product database from a current value to a new value, wherein the product identifier uniquely identifies a first product, wherein a machine-readable identification tag is attached to the first product, and wherein the machine-readable identification tag comprises an encoded version of the product identifier;
determining whether the current value is equal to one of a set of allowed values; and
changing the state to the new value only if the current value is equal to one of the set of allowed values.

11. The method as defined in claim 10, wherein the new value indicates a next action that may be taken with respect to the first product.

12. The method as defined in claim 11, wherein the new value is inspected, and wherein the set of allowed values comprises manufactured.

13. The method as defined in claim 11, wherein the new value is shipped, and wherein the set of allowed values comprises manufactured and inspected.

14. The method as defined in claim 11, wherein the new value is received, and wherein the set of allowed values comprises manufactured, inspected, and shipped.

15. The method as defined in claim 11, wherein the new value is sold, and wherein the set of allowed values comprises received and returned.

16. The method as defined in claim 11, wherein the new value is returned, and wherein the set of allowed values comprises sold.

17. The method as defined in claim 10, further comprising:
determining whether the request was sent from one of a plurality of authorized parties; and
changing the state to the new value only if the request was sent from one of the plurality of authorized parties.

18. A system for tracking products as they move through a supply chain, the system comprising:
a first product, wherein a machine-readable identification tag is attached to the first product, and wherein the machine-readable identification tag comprises an encoded version of a product identifier that uniquely identifies the first product;
an identification tag reader for scanning the machine-readable identification tag, wherein the identification tag reader is configured to decode the encoded version of the product identifier and to obtain the product identifier; and
a first computing device, the first computing device being in electronic communication with the identification tag reader, the first computing device comprising:
a processor;
memory in electronic communication with the processor; and
a client software module stored in the memory, the client software module being programmed to request that a state associated with the product identifier in a product database be changed from a current value to a new value.

19. The system as defined in claim 18, wherein the new value indicates that the first product has been manufactured.

20. The system as defined in claim 18, wherein the new value indicates a next action with respect to the first product.

21. The system as defined in claim 18, wherein a server software module stored on a second computing device controls access to the product database.

22. The system as defined in claim 21, wherein the server software module enforces a first rule which indicates that the state is not changed to the new value unless the current value is equal to one of a set of allowed values.

23. The system as defined in claim 22, wherein the server software module enforces a second rule which indicates that the state is only changeable to the new value by a plurality of authorized parties, and wherein the server software module comprises an authentication mechanism for determining whether a received request was sent by one of the plurality of authorized parties.

24. The system as defined in claim 21, wherein the first computing device and the second computing device are in electronic communication with one another over at least one network.

25. The system as defined in claim 24, wherein the client software module comprises a web browser, wherein the server software module comprises a dynamic web server, and wherein the at least one network comprises the Internet.

26. A computing device for tracking products as they move through a supply chain, the computing device comprising:
a processor;
memory in electronic communication with the processor;
a product database stored in the memory, the product database comprising a product identifier that is associated with a state, wherein a machine-readable identification tag is attached to a first product, and wherein the machine-readable identification tag comprises an encoded version of the product identifier that uniquely identifies the first product;
a server software module stored in the memory, the server software module being programmed to implement a method comprising:
receiving a request to change the state from a current value to a new value,
determining whether the current value is equal to one of a set of allowed values; and
changing the state to the new value only if the current value is equal to one of the set of allowed values.

27. The system as defined in claim 26, wherein the new value indicates that the first product has been manufactured.

28. The system as defined in claim 26, wherein the new value indicates a next action with respect to the first product.

29. The system as defined in claim 26, wherein the method further comprises:
determining whether the request was sent from one of a plurality of authorized parties; and
changing the state to the new value only if the request was sent from one of the plurality of authorized parties.
